(19) United States
(12) Patent Application Publication
(10) Pub. No.: US 2009/0288161 A1
(43) Pub. Date: Nov. 19, 2009

(54) METHOD FOR ESTABLISHING A TRUSTED RUNNING ENVIRONMENT IN THE COMPUTER

(75) Inventors: Wei Wei, Beijing (CN); Chaoran Peng, Beijing (CN); Ping Yin, Beijing (CN); Yonghua Liu, Beijing (CN)

Correspondence Address: DICKSTEIN SHAPIRO LLP, 1633 Broadway, NEW YORK, NY, 10019, US

(73) Assignee: LENOVO (BEIJING) LIMITED # 6 CHUANGYE ROAD, BEIJING (CN)

(21) Appl. No.: 11/720,640

(22) PCT Filed: Jul. 11, 2005
(86) PCT No.: PCT/CN05/01017

§ 371 Date: Jun. 1, 2007

(30) Foreign Application Priority Data
Dec. 2, 2004 (CN) 200410095576.7

(51) Int. Cl. G06F 11/00

(52) U.S. Cl. 726/22; 713/165

(57) ABSTRACT

The present invention discloses a method for establishing a trusted running environment in a computer. A trusted file authentication module and a trusted process memory code authentication module are preset in operation system (OS) of the computer and a secured OS is loaded and run. The trusted file authentication module intercepts all file operation behaviors, checks whether current file to be operated is a trusted file or not, and processes the file according to its operation type if it is trusted, otherwise processes the file after its eligibility is verified; the trusted process memory code authentication module authenticates on timing whether the running state and the integrality for all process code are normal or not; if any process is abnormal, giving an alarm, saving field data run by the process and closing down the process; otherwise continuing to run normally. With this invention, the security for the running environment in the computer can be ensured whether the attack from known or unknown virus exists or not, and this facilitates application and reduces implementation cost.

### BACKGROUND OF THE INVENTION

1. Field of Invention

The present invention relates to the technological field of computer security, in particular to a method for establishing a trusted running environment in the computer.

2. Description of Prior Art

Due to its own defects, the computer operation system (OS) is prone to an overall breakdown when attacked, especially in case of an unknown attack or a new virus. Consequently the overall system cannot continue its operation, or even it can, various problems may pop up. As such, it is inevitable for a user to doubt whether the running environment in the computer can be trusted, and thus the user may be too worried to perform processing and interaction of confidential information, such as electronic payment, electronic document and etc, on the computer. This is disadvantageous by all means.

Currently, there are usually several solutions for the above problems as follows:

The first method is to apply antivirus software. Specifically, the antivirus software detects the attack from a network virus by a method of feature matching. It isolates or disinfects any infected files when the file is found so that the computer security can be guaranteed.

This method has a disadvantage, however, in that it cannot detect the attack from an unknown virus. Consequently, the computer system cannot launch any counteraction before the publication of new virus library, rule library and patch program. Meanwhile, the antivirus software itself is susceptible to such attacks.

The second method is to apply host-invasion detection software. In particular, the host-invasion detection software detects any attack using a given feature rule library and releases an alarm.

This method has a disadvantage similar to that of the first method, that is, it cannot detect the attack from an unknown virus. Consequently, the computer system cannot launch any counteraction before the publication of new virus library, rule library and patch program. Meanwhile, the host-invasion detection software itself is susceptible to such attacks.

The third method is to utilize dual-net physical isolation, a dual-net physical isolation computer or a method of dual-mode OS switching. It specifically guarantees the security of the computer running environment through dual-net or dual-mode switching.

Unfortunately, this method will lead to an increased cost for the computer itself. And a user also needs to switch the mode of the computer and hence it is inconvenient to use.

The fourth method is to utilize process isolation technique. In detail, an identification flag is set for a process and any visitor to the process is discriminated, while different processes in the process pool are isolated and monitored with respect to their utilization for physical memory and CPU as well as to system performance in order to prevent memory overflow when multiple processes are running.

This method has a disadvantage in that it is not detected as to whether a process itself has been attacked. Therefore computer security is still in danger.

The above methods each serve as a protection measure against various attacks. However, they cannot ensure the running environment in the computer to be secured and trusted.

### SUMMARY OF THE INVENTION

In view of the above problems, the object of the present invention is to provide a method for establishing a trusted running environment in the computer, which can essentially guarantee security and trustworthiness of the running environment in the computer and facilitate user application.

In order to achieve the above object, the technical solution of the invention is realized by a method for establishing a trusted running environment in the computer, which presets a trusted file authentication module and a trusted process memory code authentication module in operation system (OS) of the computer and loads and runs a secured OS. In this method, the trusted file authentication module intercepts all file operation behaviors, checks whether the current file to be operated is a trusted file or not, and processes the file according to its operation type if it is trusted, otherwise processes the file after its eligibility is verified if it is not a trusted file. Then, the trusted process memory code authentication module authenticates on timing whether the running state and the integrality for all process code are normal or not and, if any process is abnormal, gives an alarm, saves field data run by the process and subsequently closes down the process, otherwise continues to run normally.

Preferably, said loading and running a secured OS comprises: presetting a basic file management system and a trusted file list containing file names for OS core files predefined by a user, file related to startup and application software to be protected by the user; setting in a security storage component all data requiring security guarantee and integrality value thereof; and setting in underlying firmware of the computer an fundamental software integrality authentication and recovery module of trusted OS. The process of loading and running OS further comprises the following steps:

a. after a successful authentication and startup of the underlying firmware in the computer, the underlying firmware checks whether the integrality value of the basic file management system is consistent with an integrality value prestored in the security storage component or not; and if it is, the underlying firmware starts the basic file management system and proceeds to step b; otherwise, stop system startup;

b. the basic file management system starts the fundamental software integrality authentication and recovery module of trusted OS, which in turn reads a disk parameter from a disk sector and checks whether the integrality value of the disk parameter is consistent with an integrality value prestored in the security storage component or not; and if it is consistent, step c is executed; otherwise the fundamental software integrality authentication and recovery module of trusted OS extracts disk data prestored in the security storage component, writes it in the current disk sector and then proceeds to step c;

c. the fundamental software integrality authentication and recovery module of trusted OS checks whether the integrality value of the trusted file list is consistent with an integrality value prestored in the security storage component or not; and if it is consistent, step d is executed; otherwise a trusted file list prestored in the security storage component is extracted to replace the current trusted file list and then step d is executed;

d. the fundamental software integrality authentication and recovery module of trusted OS reads the OS core files in the trusted file list and checks whether the integrality value of the OS core file is consistent with an integrality value prestored in the security storage component or not; and if it is consistent, the OS is loaded and run; otherwise, an OS core file prestored in the security storage component is extracted to replace the current OS core files and then the OS is loaded and run.

Preferably, said basic file management system is located in the security storage component, the underlying firmware or the OS; and said trusted file list is located in the security storage component or the OS.

Preferably, said all data requiring security guarantee in the security storage component is determined according to the requirement of system running and the user requirement; and said all data requiring security guarantee includes, but not limited to, data for the underlying firmware, the OS, various application software and files as well as the disk parameter.

Preferably, said disk parameter includes, but not limited to, main boot sector parameter, partition boot sector parameter and file allocation table parameter.

Preferably, the method for said trusted file authentication module to check whether the current file to be operated is a trusted file or not is: checking whether the current file to be operated is a file in the trusted file list or not; and if it is, determining the current file to be operated is a trusted file; otherwise, determining the current file to be operated is an untrusted file.

Preferably, the processing for a trusted file according to the current file operation type is: checking the type of the current file operation behavior is reading or modification, and

if it is reading, checking whether the integrality value of the current file to be operated is consistent with an integrality value prestored in the security storage component or not; and if consistent, loading the current file to be operated into the memory and allow reading from a visitor; if not consistent, extracting a prestored trusted file from the security storage component to replace the current file, and loading the current file to be operated into the memory and allow reading from the visitor, and

if it is modification, checking the computer is currently in secured state and then allowing the visitor to modify the trusted file list; recalculating the integrality values for the trusted file list and the modified file and storing their new integrality values in the security storage component.

Preferably, said modification includes, but not limited to, reading and/or attribution modification and/or deletion and/or new file creation; said secured state means that currently the computer has no physical connection with any network and the trusted file list is in a modification enabled state.

Preferably, the method further comprises providing a physical switch for enabling modification and determining whether the trusted file list is currently in the modification enabled state or not based on the on or off state of the physical switch.

Preferably, the processing for an untrusted file after its eligibility is authenticated is: after the completion of virus detection on the untrusted file, loading a process corresponding to the file into a virtual machine, which monitors the behavior of the process and gives an alarm and closes down the process if any illegal behavior is found in the process; if no illegal behavior, allowing the processing on the file.

Preferably, said illegal behavior includes at least illegal modification on OS file and/or illegal modification on disk and/or illegal boundary violation in memory access and/or illegal jumping.

Preferably, the process for said trusted process memory code authentication module to authenticate on timing whether the running state of all process code is normal or not is: checking whether the program pointer to a process exceeds physical memory address prescribed by the process or not and/or whether the process code traverses the prescribed physical memory address or not.

The process for said trusted process memory code authentication module to authenticate on timing whether the integrality of all process code is normal or not is: calculating the integrality value of process code in the memory for a process corresponding to a file when the file is loaded into the memory for the first time, storing the integrality value in the security storage component, and authenticating on timing whether the integrality value of all current process code is consistent with the integrality value prestored in the security storage component or not; if it is, determining the process code as being normal; otherwise, determining the process code as being abnormal.

Preferably, when said trusted process memory code authentication module has authenticated that the running state and/or integrality of the process code is abnormal, the method further comprises authenticating again the file corresponding to the abnormal process by the trusted file authentication module and then loading it into the memory again; calculating the integrality value of the process corresponding to the file in the memory; storing the calculated value in the security storage component; and recovering the process to its previous running state based on the field data previously saved for running the process.

Preferably, said file operation behavior includes, but not limited to, file reading/writing, file attribution modification, file deletion and file creation.

Preferably, said security storage component can be a hard disk storage component with mandatory access authorization control, a chip storage component with mandatory access authorization control or a memory component with access control mechanism.

Preferably, said storage component is a security chip, a hard disk with security protection function or a flash storage with access control function.

The present invention presets the trusted file authentication module and the trusted process memory code authentication module in operation system (OS) of the computer, and loads and runs a secured OS. The trusted file authentication module intercepts all file operation behaviors, and processes the file according to its operation type if the operation behavior is for a trusted file, while processing the file after its eligibility is verified if the operation behavior is for an untrusted file. The trusted process memory code authentication module authenticates on timing whether the running state and the integrality for all process code are normal and; if any process is abnormal, giving an alarm, saving field data run by the process and closing down the process; otherwise, continuing to run normally. With the invention, from the OS startup any attack on the OS core, application files and processes themselves is detected and the corresponding recovery is made based on a trusted computer hardware platform, instead of detecting the existence of any virus through information such as virus library or rule library. In this way, no matter whether the attack from known or unknown virus exists or not, the security and trustiness for the running environment in the computer can be ensured and thus a trusted running environment can be provided for a user who merely needs to determine which file and data requires security guarantee. This facilitates application and reduces implementation cost.

### BRIEF DESCRIPTION OF THE DRAWINGS

FIG. 1 shows a schematic flowchart for loading and running OS in which one embodiment of the invention is applied;

FIG. 2 shows a schematic flowchart for authenticating a current file to be operated by a trusted file authentication module;

FIG. 3 shows a schematic flowchart for authenticating process code by a trusted process memory code authentication module; and

FIG. 4 shows a schematic diagram for enabling modification under the control of a physical switch.

### DETAILED DESCRIPTION OF PREFERRED EMBODIMENTS

Hereafter, the present invention will be described in detail in conjunction with the accompanying figures.

According to the invention, it establishes a trust chain through overall authentication on OS, application software and processes based on a trusted computer hardware platform and thus provides a verified trusted running environment for a user.

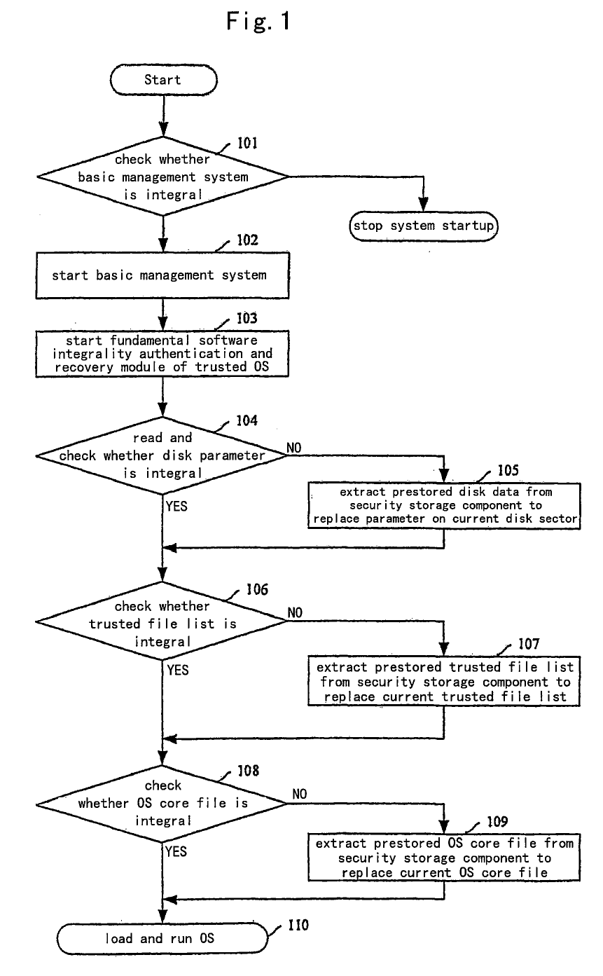

FIG. 1 shows a schematic flowchart for loading and running OS in which one embodiment of the invention is applied. In this embodiment, there is provided in underlying firmware within a computer a basic file management system having functions of disk management and file management as well as a fundamental software integrality authentication and recovery module of trusted OS, which is used for authenticating core file related to startup in the OS. All data that requires security guarantee which are determined according to requirements of system running and the user requirement, are set in a security storage component of the computer along with integrality values thereof; the data requiring security guarantee includes data for underlying firm, such as BIOS, OS, various application software and files as well as disk parameter. In addition, a trusted file list is provided containing file names for OS core file predefined by the user, file related to startup and application software that the user wants to protect. The process of loading and running OS comprises the following steps:

In step 101, after a successful authentication and startup of the underlying firmware in the computer, the underlying firmware checks whether the integrality value of the basic file management system is consistent with an integrality value prestored in the security storage component or not; if it is, step 102 is executed; otherwise, system startup is stopped.

In steps 102 and 103, the underlying firmware starts the basic file management system, which in turn starts the fundamental software integrality authentication and recovery module of trusted OS.

In step 104, the fundamental software integrality authentication and recovery module of trusted OS reads a disk parameter from a disk sector and checks whether the integrality value of the disk parameter is consistent with an integrality value prestored in the security storage component or not; if it is, step 106 is executed; otherwise, step 105 is executed.

The above disk parameter includes, but not limited to, main boot sector parameter, partition boot sector parameter and file allocation table (FAT) parameter.

In step 105, the fundamental software integrality authentication and recovery module of trusted OS extracts disk data prestored in the security storage component, to replace the current disk sector parameter and then proceeds to step 106.

In step 106, the fundamental software integrality authentication and recovery module of trusted OS checks whether the integrality value of the trusted file list is consistent with an integrality value prestored in the security storage component or not; if it is, step 108 is executed; otherwise, step 107 is executed.

In step 107, the fundamental software integrality authentication and recovery module of trusted OS extracts a trusted file list prestored in the security storage component to replace the current trusted file list and then proceeds to step 108.

In step 108, the fundamental software integrality authentication and recovery module of trusted OS reads the OS core files in the trusted file list and checks whether the integrality value of the OS core file is consistent with an integrality value prestored in the security storage component or not; if it is, step 110 is executed; otherwise, step 109 is executed.

In step 109, the fundamental software integrality authentication and recovery module of trusted OS extracts an OS core file prestored in the security storage component to replace the current OS core file and then proceeds to step 110.

In step 110, the OS is loaded and run.

So far, it is possible to ensure that the OS under in running is secured. In the above embodiment, the basic file management system is provided in the underlying firmware such that the speed for starting and booting the computer can be increased. It is obvious that the basic file management system can also be provided in the security storage component or the OS. The trusted file list can be provided in the security storage component or the OS.

After the OS enters into normal running, the trusted file authentication module is started to authenticate the current file to be operated and the trusted process memory code authentication module is also started to authenticate the running state and integrality for all process code so as to ensure the security for the running environment in the computer. Next, the authentication methods for the trusted file authentication module and the trusted process memory code authentication module will be explained respectively.

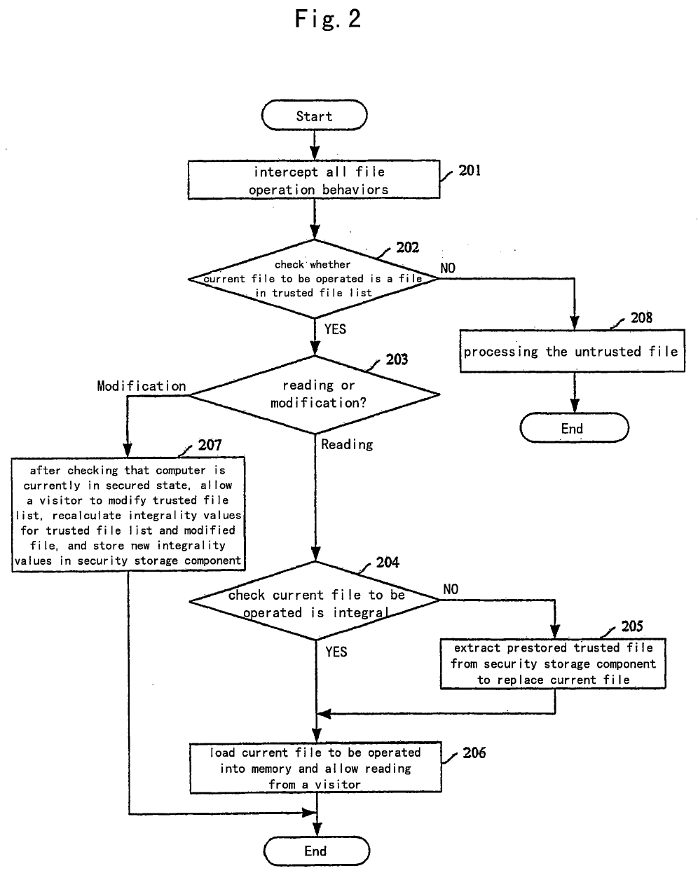

FIG. 2 shows a schematic flowchart for authenticating a current file to be operated by the trusted file authentication module.

In step 201, the trusted file authentication module intercepts all file operation behaviors including file reading/writing, file attribution modification, file deletion and file creation.

In step 202, the trusted file authentication module checks whether the current file to be operated is a file in the trusted file list or not; if it is, proceeding to step 203; otherwise, proceeding to step 208.

In step 203, the type of the current file operation behavior is checked; step 204 is executed if the type is reading; step 207 is executed if it is modification.

In step 204, it is checked whether the integrality value of the current file to be operated is consistent with an integrality value prestored in the security storage component or not; if they are consistent, step 206 is executed; otherwise, step 205 is executed.

In step 205, a prestored trusted file is extracted from the security storage component to replace the current file.

In step 206, the current file to be operated is loaded into the memory and reading from a visitor is allowed, then the flow is ended.

In step 207, after it is checked that the computer is currently in secured state, the visitor is allowed to modify the trusted file list; the integrality values for the trusted file list and the modified file are recalculated and stored in the security storage component. The flow is then ended.

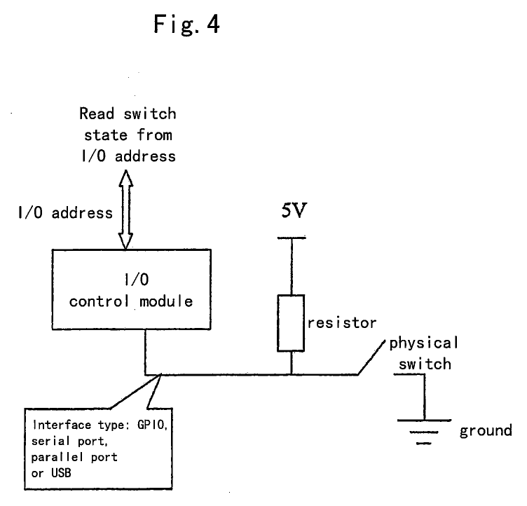

The above modification includes, but not limited to, writing and/or attribution modification and/or deletion and /or new file creation. The process for checking whether the computer is currently in secured state or not is: checking whether or not the computer currently has physical connection with any network and the trusted file list is in a modification enabled state. The so-called modification enabled state is a state in which a security physical switch is enabled. Now turning to FIG. 4, which shows a schematic diagram for enabling modification under the control of the physical switch. One physical switch for enabling modification is provided to connect to the ground at one end and to I/O control module on the main board of the computer at the other end. The I/O control module can be realized in a chip set or CPU. The interface between the physical switch and the I/O control module can be, but not limited to, GPIO, serial port, parallel port or USB port. When it is checked whether the trusted file list is currently in the modification enable state or not, “ON” or “OFF” state of the physical switch is read at the I/O address for the physical switch, and it is determined that the trusted file list is currently in the modification enabled state if the physical switch is in “OFF” state if the physical switch is in “ON” state, the trusted file list is currently in a modification disabled state.

In step 208, after the completion of virus detection on the untrusted file, a process corresponding to the file is loaded into a virtual machine, which monitors the behavior of the process and gives an alarm and closes down the process if any illegal behavior is found in the process; if no illegal behavior, allowing the operation on the file.

The above virtual machine is a kind of software running in the computer and simulates the monitor on the process behavior by a real computer. The above illegal behavior includes at least illegal modification on OS file and/or illegal modification on disk and/or illegal boundary violation in memory access and/or illegal jumping.

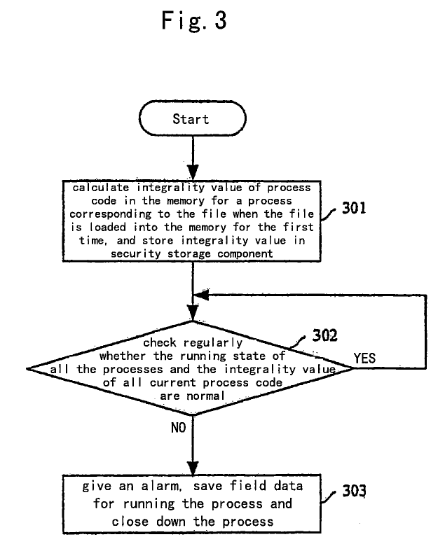

FIG. 3 shows a schematic flowchart for authenticating process code by the trusted process memory code authentication module.

In step 301, after the file is confirmed as a trusted file, the integrality value of process code in the memory for a process corresponding to the file is calculated when the file is loaded into the memory for the first time, and the integrality value is stored in the security storage component.

In step 302, the trusted process memory code authentication module authenticates on timing whether the running state of all the processes and the integrality value of all current process code are normal or not; if it is so, proceeds to step 303, otherwise continues the normal execution and repeats regularly step 302.

The above process for authenticating whether the running state of all process code is normal or not is: checking whether a pointer to a process program exceeds physical memory address prescribed by the process or not, and/or whether the process code traverses the prescribed physical memory address or not. The process for authenticating whether the integrality of all process code is normal or not is: authenticating whether the integrality value of all current process code is consistent with the integrality value prestored in the security storage component or not; if it is, determining the process code is normal; otherwise, abnormal.

Wherein, the operation for checking whether a pointer to a process program exceeds physical memory address prescribed by the process or not, and/or whether the process code traverses the prescribed physical memory address or not can be realized in software, CPU or chip set.

In step 303, an alarm is given. Field data for running the process is saved and the process is closed down. The file corresponding to the abnormal process can be authenticated again by the trusted file authentication module and then loaded into the memory again. The integrality value of the process corresponding to the file in the memory can be recalculated and stored in the security storage component. The process can be recovered to its previous running state based on the field data previously saved for running the process.

The above-mentioned security storage component can be a hard disk storage component with mandatory access control authorization, a chip storage component with mandatory access authorization control or a memory component with access control mechanism. The protection for the above hard disk storage component is fulfilled by a hard disk control logic circuit and independent of hard disk logic partition and OS partition. The so-called mandatory access control authorization means that the security storage component can identify a visitor based on password and accept access from the visitor only when the identification is successful, or that the security storage component and the visitor utilize a pair of secret information shared in advance and certification protocol based on the calculation involving hash function and random number to certify the visitor's identity, and the security storage component accepts the access only when the certification is successful.

Specifically, the above-mentioned security storage component can be a security chip (e.g.,TPM, Trusted Plafform Module), a hard disk with security protection function, such as a hard disk with HPA (Host Protected Area) or a flash storage with access control function. A detail description to the security chip has been disclosed in the application CN03138380.7 “A Security chip and Information Security Processing Device and Method Based on the Chip” by the applicant, which will not be repeated here. Moreover, the method for authenticating underlying firmware in the computer has been illustrated in the application, so it will not be repeated in step 101.

The above is merely preferred embodiments of the present invention and not intended to limit the invention. Any change, substitution or modification made within the spirit and principle of the invention should be encompassed in the scope of the invention.

1. A method for establishing a trusted running environment in a computer, wherein a trusted file authentication module and a trusted process memory code authentication module are preset in operation system (OS) of the computer and a secured OS is loaded and run, the method comprising:
the trusted file authentication module intercepts all file operation behaviors, checks whether current file to be operated is a trusted file or not, and processes the file according to its operation type if it is trusted, otherwise processes the file after its eligibility is verified;
the trusted process memory code authentication module authenticates on timing whether the running state and the integrality for all process code are normal or not; if any process is abnormal, giving an alarm, saving field data run by the process and closing down the process; otherwise continuing to run normally.

2. The method according to claim 1, wherein said loading and running a secured OS comprises: presetting a basic file management system and a trusted file list containing file names for OS core files predefined by a user, files related to startup and application software to be protected by the user; setting in a security storage component all data requiring security guarantee and integrality value thereof; and setting in underlying firmware of the computer an fundamental software integrality authentication and recovery module of trusted OS; the process of loading and running OS comprises:
a. after a successful authentication and startup of the underlying firmware in the computer, the underlying firmware checks whether the integrality value of the basic file management system is consistent with an integrality value prestored in the security storage component or not; if it is, the underlying firmware starts the basic file management system and then proceeds to step b; otherwise, stopping system startup;
b. the basic file management system starts the fundamental software integrality authentication and recovery module of trusted OS, which reads a disk parameter from a disk sector and checks whether the integrality value of the disk parameter is consistent with an integrality value prestored in the security storage component or not; if it is, step c is executed; otherwise, the fundamental software integrality authentication and recovery module of trusted OS extracts disk data prestored in the security storage component, writes it in the current disk sector and proceeds to step c;
c. the fundamental software integrality authentication and recovery module of trusted OS checks whether the integrality value of the trusted file list is consistent with an integrality value prestored in the security storage component or not; if it is, step d is executed; otherwise, a trusted file list prestored in the security storage component is extracted to replace the current trusted file list and then step d is executed;
d. the fundamental software integrality authentication and recovery module of trusted OS reads the OS core files in the trusted file list and checks whether the integrality value of the OS core file is consistent with an integrality value prestored in the security storage component or not; if it is, the OS is loaded and run; otherwise, an OS core file prestored in the security storage component is extracted to replace the current OS core file and the OS is loaded and run.

3. The method according to claim 2, wherein said basic file management system is located in the security storage component, the underlying firmware or the OS, and said trusted file list is located in the security storage component or the OS.

4. The method according to claim 2, wherein said all data requiring security guarantee in the security storage component is determined according to the requirement of system running and the user requirement; and said all data requiring security guarantee includes, but not limited to, data for the underlying firmware, the OS, various application software and files as well as the disk parameter.

5. The method according to claim 2, wherein said disk parameter includes, but not limited to, main boot sector parameter, partition boot sector parameter and file allocation table parameter.

6. The method according to claim 2, wherein the method for said trusted file authentication module to check whether the current file to be operated is a trusted file or not is: checking whether the current file to be operated is a file in the trusted file list or not; if it is, determining the current file to be operated is a trusted file; otherwise, determining the current file to be operated is an untrusted file.

7. The method according to claim 6, wherein the processing for a trusted file according to the current file operation type is: checking the type of the current file operation behavior is reading or modification, and
if it is reading, checking whether the integrality value of the current file to be operated is consistent with an integrality value prestored in the security storage component or not; if they are consistent, loading the current file to be operated into the memory and allowing reading from a visitor; otherwise, extracting a prestored trusted file from the security storage component to replace the current file, and loading the current file to be operated into the memory and allowing reading from the visitor, and
if it is modification, checking the computer is currently in secured state and allowing the visitor to modify the trusted file list, recalculating the integrality values for the trusted file list and the modified file and storing their new integrality values in the security storage component.

8. The method according to claim 7, wherein said modification includes, but not limited to, reading and/or attribution modification and/or deletion and /or new file creation; said secured state means that currently the computer has no physical connection with any network and the trusted file list is in a modification enabled state.

9. The method according to claim 8, further comprises providing a physical switch for enabling modification and determining whether the trusted file list is currently in the modification enabled state or not based on the on or off state of the physical switch.

10. The method according to claim 6, wherein the processing for an untrusted file after its eligibility is authenticated is: after the completion of virus detection on the untrusted file, loading a process corresponding to the file into a virtual machine, which monitors the behavior of the process; giving an alarm and closing down the process if any illegal behavior is found in the process; if no illegal behavior, allowing the processing on the file.

11. The method according to claim 10, wherein said illegal behavior includes at least illegal modification on OS file and/or illegal modification on disk and/or illegal boundary violation in memory access and/or illegal jumping.

12. The method according to claim 2, wherein the process for said trusted process memory code authentication module to authenticate on timing whether the running state of all process code is normal or not is: checking whether a pointer to a process program exceeds physical memory address prescribed by the process or not, and/or whether the process code traverses the prescribed physical memory address or not;
the process for said trusted process memory code authentication module to authenticate on timing whether the integrality of all process code is normal or not is: calculating the integrality value of process code in the memory for a process corresponding to a file when the file is loaded into the memory for the first time; storing the integrality value in the security storage component, and authenticating on timing whether the integrality value of all current process code is consistent with the integrality value prestored in the security storage component or not; if it is, determining that the process code is normal; otherwise, determining that the process code is abnormal.

13. The method according to claim 12, wherein when said trusted process memory code authentication module has authenticated that the running state and/or integrality of the process code is abnormal, the method further comprises: authenticating again the file corresponding to the abnormal process by the trusted file authentication module; loading it into the memory again; calculating the integrality value of the process corresponding to the file in the memory; storing the calculated value in the security storage component; and recovering the process to its previous running state based on the field data previously saved for running the process.

14. The method according to claim 1, wherein said file operation behavior includes, but not limited to, file reading/writing, file attribution modification, file deletion and file creation.

15. The method according to claim 2, wherein said security storage component can be a hard disk storage component with mandatory access control authorization, a chip storage component with mandatory access authorization control or a memory component with access control mechanism.

16. The method according to claim 2, wherein said storage component is a security chip, a hard disk with security protection function or a flash storage with access control function.

17. The method according to claim 4, wherein said disk parameter includes, but not limited to, main boot sector parameter, partition boot sector parameter and file allocation table parameter.

18. The method according to claim 3 wherein said security storage component can be a hard disk storage component with mandatory access control authorization, a chip storage component with mandatory access authorization control or a memory component with access control mechanism.

19. The method according to claim 4, wherein said security storage component can be a hard disk storage component with mandatory access control authorization, a chip storage component with mandatory access authorization control or a memory component with access control mechanism.

20. The method according to claim 7, wherein said security storage component can be a hard disk storage component with mandatory access control authorization, a chip storage component with mandatory access authorization control or a memory component with access control mechanism.

21. The method according to claim 12, wherein said security storage component can be a hard disk storage component with mandatory access control authorization, a chip storage component with mandatory access authorization control or a memory component with access control mechanism.

22. The method according to claim 3, wherein said storage component is a security chip, a hard disk with security protection function or a flash storage with access control function.

23. The method according to claim 4, wherein said storage component is a security chip, a hard disk with security protection function or a flash storage with access control function.

24. The method according to claim 7, wherein said storage component is a security chip, a hard disk with security protection function or a flash storage with access control function.

25. The method according to claim 12, wherein said storage component is a security chip, a hard disk with security protection function or a flash storage with access control function.
